(19) United States
(12) Patent Application Publication
(10) Pub. No.: US 2011/0035257 A1
(43) Pub. Date: Feb. 10, 2011

(54) Systems And Methods For Generating Planograms In The Presence Of Multiple Objectives

(76) Inventors: Rajendra Singh Solanki, Cary, NC (US); Seung Hyun Kong, Cary, NC (US); Jennie (Jing) Hu, Cary, NC (US)

Correspondence Address: Patent Group 2N;Jones Day, North Point, 901 Lakeside Avenue, Cleveland, OH, 44114, US

(21) Appl. No.: 12/537,023

(22) Filed: Aug. 6, 2009

(51) Int. Cl. G06Q 10/00; G06N 5/02; G06Q 50/00

(52) U.S. Cl. 705/10; 706/47

(57) ABSTRACT

Systems and methods for an item placement configuration optimization are provided. A system and method can include receiving a first selection including two or more first items corresponding to a first level in an item placement configuration. A first score is determined for the first selection by applying an algorithm to data corresponding to the first items. A second selection including two or more second items and corresponding to a second level in the item placement configuration is received. A second score for the second selection is determined by applying an algorithm to the first score and data corresponding to the second items.

### TECHNICAL FIELD

The present disclosure relates generally to computer-implemented systems and methods for planogram optimization, more specifically, for generating planograms in the presence of multiple objectives.

### BACKGROUND

A planogram is an item placement configuration, or a diagram of fixtures and products that illustrates how and where retail products should be displayed (e.g., a store shelf), in order to increase customer purchases. Planograms differ significantly by retail sector. Fast-moving consumer goods organizations and supermarkets largely use text and box based planograms that optimize shelf space, inventory turns, and profit margins. Apparel brands and retailers are more focused on presentation and use pictorial planograms that illustrate “the look” and also identify each product.

A planogram is often received before a product reaches a store, and is useful when a retailer wants multiple store displays to have the same look and feel. The same planogram can be used in multiple stores if a common shelf configuration, same merchandise assortment, and similar product demand exist for these merchandise store combinations. Because these elements vary by store size and geographical regions, a typical major retailer must maintain a large number (e.g., tens of thousands) of planograms.

Proper utilization of shelf space is critical in meeting demands for products and providing a good customer experience in a retail environment. A planogram defines which product is placed in which area of a shelving unit and with which quantity. Often a consumer packaged goods manufacturer will release a new suggested planogram with their new product, to show how it relates to existing products in the same category.

While a suggested planogram can assist a retailer in displaying products on shelves, often other positions and facings of the products would result in a better customer experience. For example, a retailer may need to make adjustments to the suggested planogram because the dimensions in their particular retail environment differ from those in the suggested planogram.

### SUMMARY

In accordance with the teachings provided herein, systems and methods for an item placement configuration optimization are provided. For example, a system and method can be configured to receive a first selection including two or more first items corresponding to a first level in an item placement configuration. A first score is determined for the first selection by applying an algorithm to data corresponding to the first items. A second selection including two or more second items and corresponding to a second level in the item placement configuration is received. A second score for the second selection is determined by applying an algorithm to the first score and data corresponding to the second items.

In some implementations, the system and method can be further configured to determine if there is a saved score corresponding the first selection, and to use the higher of the saved score or the first score to determine the second score. In other implementations, the system and method can be further configured to replace the saved score with the first score, when the first score is higher. In yet other implementations, the system and method can be further configured to optimize the item placement configuration according to one or more objectives including a facings objective, a shape objective, or a sequence objective.

Particular embodiments of the subject matter described in this specification can be implemented to realize one or more of the following advantages. Planograms can be generated and optimized quickly to suit the needs of a particular venue. Pianograms can be generated by achieving a balance among competing objectives.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 shows a block diagram of an example system for planogram optimization.

FIG. 2 shows an example display of the three axes comprising shelf and product attributes.

FIG. 3 shows a block diagram of an example system for optimizing planogram configurations with respect to one or more objectives.

FIG. 4 shows a block diagram of an example planogram hierarchy.

FIG. 5 shows an example planogram.

FIG. 6 shows a block diagram example process for phase one.

FIG. 7 shows a block diagram example process that can be used to solve for an optimal box at every level in a hierarchical planogram.

FIG. 8 shows an example planogram before optimization.

FIG. 9 shows an example planogram after optimization.

FIG. 10 shows an example planogram.

FIG. 11 shows an example planogram.

FIG. 12 shows an example planogram.

FIG. 13 shows an example planogram.

Like reference numbers and designations in the various drawings indicate like elements.

### DETAILED DESCRIPTION

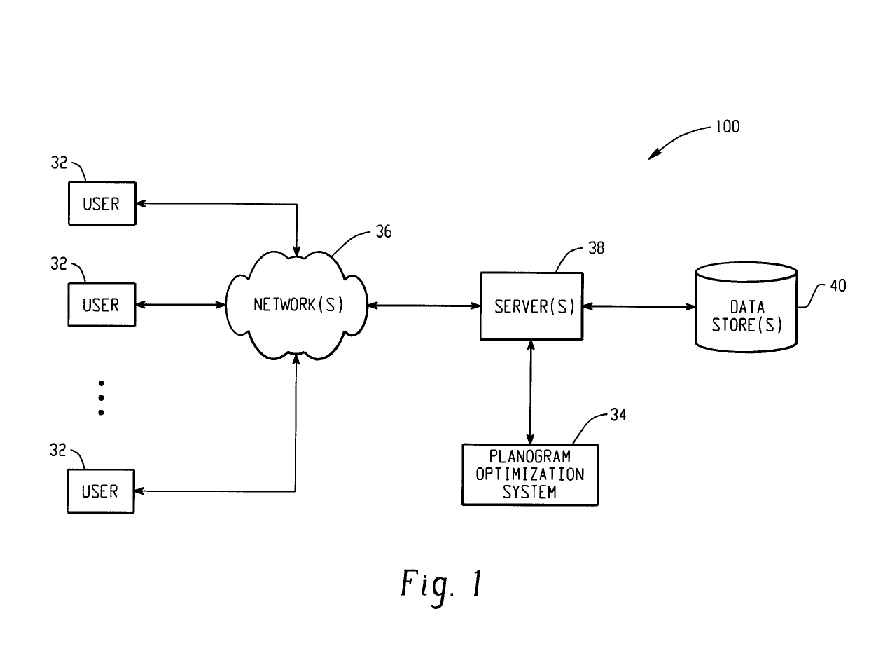

FIG. 1 shows a block diagram of an example system 100 for planogram optimization. System 100 can be a computer-implemented environment wherein one or more users 32 can interact with a planogram optimization system 34 hosted on one or more servers 38 through a network 36. The planogram optimization system 34 contains software operations or routines for solving a planogram opitimization problem. The planogram optimization system 34 can compute optimal positions and facings of products on shelves in a retail store by balancing several objectives and scoring combinations (e.g., of one or more products and one or more shelves), on each level of a planogram hierarchy. For example, types of objectives can include a facings objective (e.g., to minimize the deviation of facings placed in the plaonogram from the recommended facings for individual products), a shape objective (e.g., to place products in uniform rectangular shapes over multiple shelves based on product attributes such as function, brand, and price range), and sequence objectives (e.g., to maintain a desired relative position among products and groups of products in both horizontal and vertical directions).

The users 32 can interact with the planogram optimization system 34 through a number of ways, such as over one or more networks 36. One or more servers 38 accessible through the network(s) 36 can host the planogram optimization system 34. It should be understood that the system 34 could also be provided on a stand-alone computer for access by a user.

The planogram optimization system 34 can be an integrated web-based analysis tool that provides users flexibility and functionality for performing planogram optimization determinations and analysis or can be a wholly automated system. One or more data stores 40 can store the data to be analyzed by the planogram optimization system 34 as well as any intermediate or final data generated by the planogram optimization system 34. For example, data store(s) 40 can store constraints for use in determining the optimal planograms to be utilized (e.g., based on particular constraints). Examples of data store(s) 40 can include relational database management systems (RDBMS), or a multi-dimensional database (MDDB), such as an Online Analytical Processing (OLAP) database, etc.

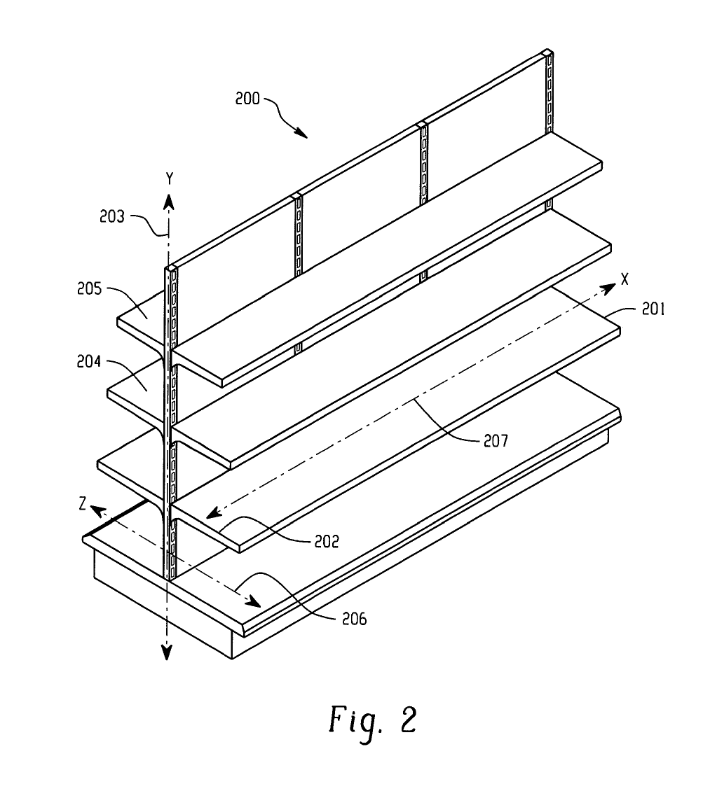

FIG. 2 shows an example display 200 of the three axes comprising shelf and product attributes. In some implementations, the arrangement and dimensions of shelves are defined using one or more attributes for each shelf in the planogram. For example, shelf attributes can include, but are not limited to: the starting position 201 of the shelf along X-axis 207 and the ending position 202 of the shelf along X-axis 207. In this example, the shelf width can then be determined by calculating the difference between the ending position and starting position along the X-axis 207.

Another shelf attribute is the position of the shelf along the Y-axis 203. For example, the merchandisable height of a shelf can be determined by calculating the difference between the Y-positions of a shelf (e.g., shelf 204), and the shelf directly above it (e.g., shelf 205). In some implementations, shelves can be labeled top, middle, and bottom depending on their relative positions along the Y-axis 203 (e.g., with respect to the other shelves).

Yet another shelf attribute is the depth of shelf (e.g., the size of the shelf along the Z-axis 206). For example, the merchandisable height and the merchandisable depth of a shelf can be used in calculating the inventory of a product placed on the shelf (e.g., by placing one facing of the product). In this example, the merchandisable height of a shelf can be used for stacking the product along the Y-axis 203 and the merchandisable depth of a shelf can be used for placing multiple units of a product along the Z-axis 206.

Another shelf attribute is its designation as a pallet shelf. A shelf is considered to be a pallet shelf if it presents a product in the form of a pallet. A product can be displayed as a pallet (e.g., if the demand for the product is very high), and the product requires excessive shelf space in a non-pallet display.

In some implementations, placement of products on shelves is defined using one or more attributes for each product in the planogram. For example, product attributes can include, but are not limited to: the width of one unit of the product, the height of one unit of the product, or the depth of one unit of the product. Additional attributes include the recommended or desired number of facings of a product (e.g., as indicated by the demand for a product in a replenishment cycle), the minimum number of facings allowed for the product (e.g., by agreement between the manufacturer and the retailer), and the maximum number of facings allowed for the product (e.g., by agreement between the manufacturer and the retailer). Product facing can include both the act of “facing” the product (e.g., placing a product at the end of a shelf with the label facing outward), and the placement or the product (e.g., on the shelf or with respect to other products).

In some implementations, when recommended facings result in unused shelf space or insufficient shelf space, a product rank attribute can be used to increase or decrease the number of facings of the product. In some implementations, products can be ranked based on their financial impact (e.g., revenue or margin). In some implementations, if increasing facings, products of higher ranks can be selected first, and if decreasing facings, products of lower ranks can be selected first.

Another product attribute is the X-axis 207 preference. This product attribute specifies the preference of product placement along X-axis 207. For example, premium products (e.g., premium brands with high demand or margin), are typically placed first in the direction of traffic, followed by secondary or economy products. Yet another product attribute is the Y-axis 203 preference. This product attribute specifies the preference of product placement along Y-axis 203 with respect to the top, middle, or bottom shelves. For example, a product can be specified to be preferentially placed on a top, middle, or bottom shelf. High margin or slow moving products are typically preferred on top shelves, medium margin and fast moving products are typically preferred on middle shelves, and low margin or bulky products are typically preferred on bottom shelves.

In some implementations, the placement of each individual product is considered. In some implementations, specific products can not be stacked (e.g., boxes or cans can be stacked but bottles cannot be stacked). In some implementations, groups of products are placed together on shelves. For example, groups of products are placed together when products in a group should remain together and not be mixed with products in other groups. In these implementations, the products in a planogram can be arranged in a hierarchy.

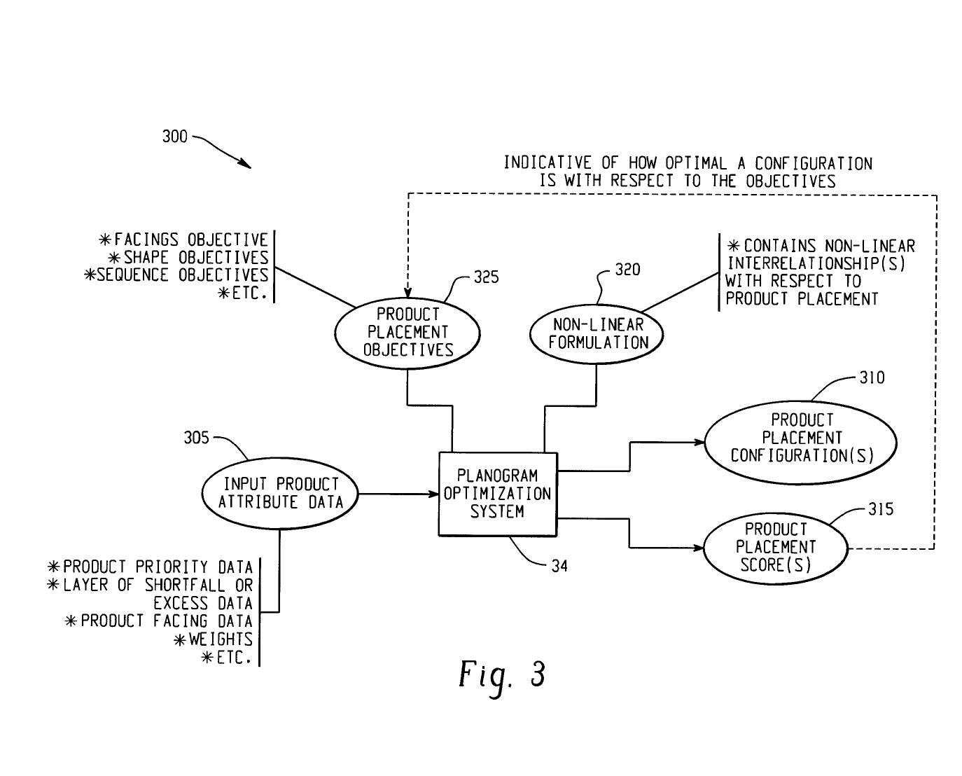

FIG. 3 shows a block diagram of an example system 300 for optimizing planogram configurations with respect to one or more objectives. As noted above, the planogram optimization system 34 can determine placements of products with respect to one or more shelves. In some implementations, the planogram optimization system 34 receives product placement attribute data 305. For example, placement attribute data can include any combination of product priority data, layer of shortfall or excess data, product facing data, or product placement preferences.

After receiving the product placement attribute data 305, the planogram optimization system 34 creates one or more product placement configurations 310 (e.g., with respect to one or more shelves). Additionally, in some implementations, the planogram optimization system 34 can create one or more product placement scores 315. In some implementations, the one or more product placement scores 315 can be created by solving a non-linear product placement mathematical formulation 320 (e.g., containing one or more non-linear interrelationship(s) with respect to the product placement attribute data 305), using the product placement attribute data 305 and one or more product placement objectives 325.

In some implementations, each of the product placement configurations 310 can be associated with a product placement score 315. In these implementations, the one or more product placement scores 315 can indicate the extent to which the associated product placement configuration 310 is desirable with respect to one or more product placement objectives 325. Product placement objectives 325 (e.g., facings, shape, or sequence objectives), can include preferred product configuration features. Product placement objectives 325 will be discussed in greater detail with respect to FIG. 5 below.

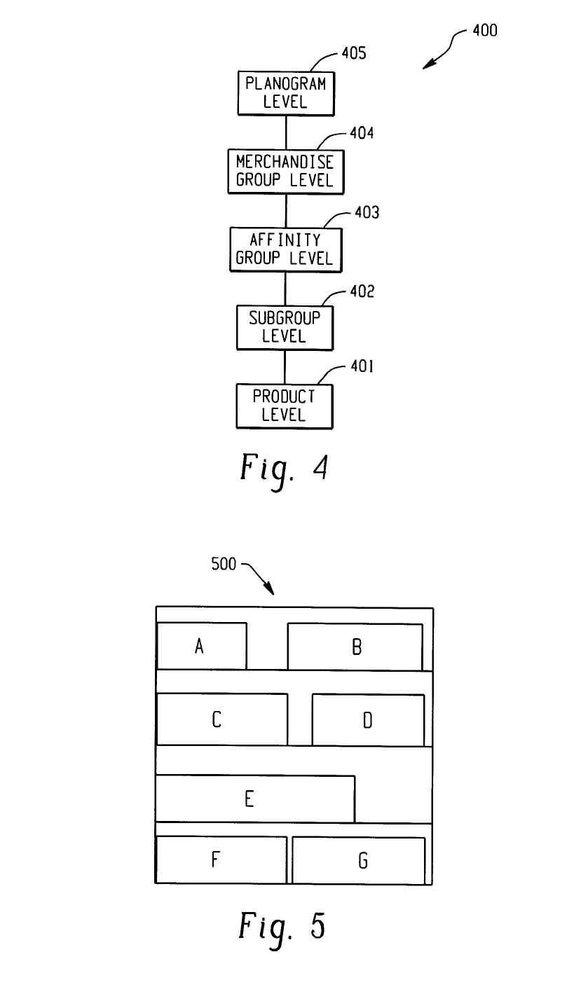

FIG. 4 shows a block diagram of an example planogram hierarchy 400. In this example, the planogram hierarchical arrangement has four levels, a product level 401, a subgroup level 402, an affinity group level 403, a merchandise group 404, and a planogram level 405. Each level in the planogram hierarchical arrangement can include one or more other levels including one or more products or groups of products. For example, the planogram level 405 can include one or more merchandise groups 404. The merchandise group 404 can include several lower level or affinity groups 403. Likewise, an affinity group 403 can include several lower level or subgroups 402.

The hierarchy is usually formed by using product data (e.g., function, name, brand, size, dimensions, weight, image, cost, manufacturer's suggested retail price, price range, and item case pack requirement). For example, products of one brand can be grouped together and placed separate from products of other brands. Likewise, the placement of a group of products (e.g., an affinity group 403), should not be mixed with other affinity groups 403. At the lowest level of the hierarchy (e.g., the product level 401), facings of a particular product should remain next to one other and should not be mixed with facings of other products In some implementations, product hierarchy information can be determined by a user and provided as input into the system to facilitate planogram optimization.

An ability to quickly compute and generate optimal planogram hierarchies 400 (“planograms”), can be essential for a retailer (e.g., when changing product assortments, when accommodating product demands, or when conforming to retail venue requirements). In some implementations, an optimal planogram can be determined by balancing competing objectives such as facing, shape, and sequence objectives, to arrive at a solution that achieves or exceeds acceptable levels of these objectives. For example, an existing placement can be preferred over other placements (e.g., a recommended number of facings), if it achieves the highest score (e.g., using a weighted sum of the three objectives).

In some implementations, existing placements can be compared with a recommended number of facings for all placed products by using the following function, and accounting for both shortfall and excess with respect to the recommended number of facings. In these implementations, a best score of 100 can be achieved when all the placed products have the recommended number of facings.

$$s = 100 \cdot \frac{1}{{\sum }_{p} {k}_{p}} ( {\sum }_{p} {\sum }_{l} {k}_{p} {w}_{l} \frac{{F}_{pl} - {f}_{pl}}{{F}_{pl}} + {\sum }_{p} {\sum }_{I} {k}_{K - {I}_{p} + 1} {w}_{l} \frac{{E}_{pl} - {e}_{pl}}{{E}_{pl}} )$$

### Where:

p—product p
l—layer of shortfall or excess
kₚ—priority of product p based on a subassortment KPI of choice
Iₚ—index of the priority of product
K—possible number of priority values (e.g., 4, if products are divided in four categories based on a subassortment KPI of choice). In this case, priority Iₚ for product p can be from 1 to 4 depending on the KPI value of product p. Four priority values (kₚ) used in this example are 1.75, 1.5, 1.25, and 1 with corresponding indices (Iₚ) of 1, 2, 3, and 4 respectively.
rₚ—recommended number of facings for product p

Shortfall and excess in placing the recommended number of facings can be modelled as the sum of four variables each. Thus, shortfall and excess in placing product facings can be captured as:

nₚ+fₚ₁+fₚ₂+fₚ₃+fₚ₄−eₚ₁−eₚ₂−eₚ₃eₚ₄=rₚ

### Where:

nₚ—number of actual facings of product p
fₚ₁—shortfall in layer l while placing product p where shortfall in layer l can be positive only if layers 1 through l-1 have been fully utilized.
A typical setting of four layers of shortfall ranges is shown:
layer 1: shortfall fₚ₁ is between 0 to 10% of recommended facings
layer 2: shortfall fₚ₂ where fₚ₁+fₚ₂ is between 10 to 30% of recommended facings
layer 3: shortfall fₚ₃ where fₚ₁+fₚ₂+fₚ₃ is between 30 to 80% of recommended facings
layer 4: shortfall fₚ₄ where fₚ₁+fₚ₂+fₚ₃₊fₚ₄ is between 80 to 100% of recommended facings
Fₚ₁—upper limit on shortfall in layer l. Thus Fₚ₁ in the example above is 10% of recommended facings. Value of Fₚ₂ is 30%−10%=20% of recommended facings.
w₁—weighted coefficient in the objective for shortfall or excess in layer l. Assuming non-weighted values of 1, 4, 20, and 25 for the four layers, values of w₁ are set as:

w₁=1/(1+4+20+25)=0.02

w₂=4/(1+4+20+25)=0.08

w₃=20/(1+4+20+25)=0.40

w₄=25/(1+4+20+25)=0.50
eₚ₁ and Eₚ₁ are defined as excess facings in layer l and upper limit on excess in layer l similar to fₚ₁ and Fₚ₁

FIG. 5 is an example planogram 500 including 7 placed products (A, B, C, D, E, F, and G). Chart 1 below, includes recommended facings for FIG. 5. The recommended facings can be compared to actual facings in FIG. 5 using the scoring method below. In this example, Product E is scored.

| | CHART 1 | | | | | | |
|---|---|---|---|---|---|---|---|
| | Product | | | | | | |
| | A | B | C | D | E | F | G |
| Recommended | 2 | 4 | 2 | 2 | 5 | 4 | 3 |
| facings | | | | | | | |
| KPI based | 1.75 | 1.75 | 1.5 | 1.5 | 1.25 | 1 | 1 |
| Priority | | | | | | | |
| Actual | 2 | 4 | 2 | 2 | 6 | 3 | 2 |
| facings | | | | | (excess) | (short) | (short) |
| X₁ | 1 | 1 | 1 | 1 | 0 | 0 | 0 |
| X₂ | 1 | 1 | 1 | 1 | 0.5 | 0.25 | 0 |
| X₃ | 1 | 1 | 1 | 1 | 1 | 1 | 0.9333 |
| X₄ | 1 | 1 | 1 | 1 | 1 | 1 | 1 |

Where x₁ denotes (Fₚ₁−fₚ₁)/Fₚ₁ or (Eₚ₁−eₚ₁)/Eₚ₁ depending on the presence of shortfall (F) or excess (E) in actual facings for layer l.

### Scoring for Product E:

Product E has an excess of 1 facing.
Layer 1 covers excess from 0 to 0.5 (10% of the recommended facings, i.e. 5).
Thus excess in layer 1 results in (Eₚ₁−eₚ₁)/Eₚ₁=(0.5−0.5)/0.5=0.
Layer 2 goes from excess of 0.5 to 1.5. Excess in layer 2 results in

(Eₚ₂−eₚ₂)/Eₚ₂=(1.0−0.5)/1.0=0.5
Since product E (priority index of 2) has excess facings, we need to use a priority with an index of (4−2+1=3) which is 1.5. Applying the priority and weighted coefficients for the layers related to excess leads to:

1.5*(0+4*0.5+20*1+25*1)/50=1.5*47/50=1.5*0.94
In this example, Product E doesn't have a shortfall; hence Product E has a perfect score of 1 in shortfall layers.
Scores for each product are added in both the excess and the shortfall layers and the sum is divided by the sum of priorities to get the final score:

Score=100*(1.75*1+1.75*1+1.5*1+1.5*1+1.25*1+0.92+0.87333+1+1+1.25*1+1.25*1+1.5*0.94+1.75*1+1.75*1)/2*(1.75+1.75+1.5+1.5+1+1)=98.47

In this example, Product E received a score of 98.47. This score can be used to determine whether the actual facings for Product E need to be changed (e.g., to better conform to the recommended number of facings for Product E). For example, changing the actual number of facings for Product E to 5 will lead to a different score. Thus, if the actual number of facings for Product E is 5, then the score will be 100, because the actual number of facings matches the recommended number of facings, and therefore all penalty terms become zero. Scores can then be compared and a highest score can be chosen for the Product E facing.

Referring again to FIG. 4, in some implementations, scoring begins on the lowest level of the hierarchy where there is a product or group. For example, scoring can begin on the product level 401 of the planogram hierarchy, and a score can be computed for each product on that level. Highest scores for each product on the product level 401 can then be determined and those scores can then be used to score groups of products in the next level up in the hierarchical planogram (e.g., the subgroup level 402). Highest scores for groups of products and combinations of groups of products can then be determined for the subgroup level 402. These highest scores can then be used to score groups of products or combinations of groups of products in the next level up on the hierarchical planogram (e.g., the affinity group level 403).

Like wise, highest scoring groups in the affinity group level 403 can be used to score groups of products or combinations of groups of products in the next level up on the hierarchical planogram (e.g., the merchandise group level 404). Finally, highest scoring groups in the merchandise group 404 can be used to formulate the final overall planogram 405. Additionally, at every level of scoring, scores can be saved for repeated use in a variety of different scoring combinations (e.g., within a particular level or among multiple levels).

As noted above, an optimal planogram can be determined by balancing competing objectives such as facing, shape, and sequence objectives, wherein a weighted sum of the objectives can be used to determine the highest score. The facings objectives can minimize the deviation of facings placed in the planogram (e.g., from the recommended facings for individual products). For example, a decrease in the number of facings (e.g., to fit one or more available space objectives) can minimize the deviation in the number of placed facings in view of the recommended number of facings (e.g., in order to accommodate the products on the available shelf space). In another example, an increase in the number of facings (e.g., to fill one or more available space objectives), can minimize unused shelf space by increasing the number of placed facings in light of the number of recommended facings (e.g., when excess shelf space is available).

The shape objectives can address the aesthetic feel of the planogram. For example, an adjusted horizontal span can indicate a need to place a group of products on multiple shelves (e.g., when the use of fewer shelves results in a rectangular shape wider than the desired horizontal span). In another example, an adjusted vertical span objective can indicate a need to place a group of products on all shelves from the top to the bottom of the planogram (e.g., if the group needs sufficient shelf space to cover all shelves from top to bottom while consuming a desired width of space on each shelf). In yet another example, a balanced horizontal/vertical span objective can minimize usage of unequal shelf space by a group of products over multiple shelves (e.g., to avoid jagged edges in placing a group of products and to improve customer experience when locating a product on shelf).

The sequence objectives maintain the desired relative position among products and groups of products with respect to both the horizontal and vertical directions. For example, the maintain horizontal sequence objective can sequence products along the horizontal axis in the direction of traffic (e.g., when premium brands or products should be placed first in the direction of traffic, followed by secondary and economy products). The maintain vertical sequence objective can maintain desired vertical positions of products or groups of products along the vertical axis (e.g., when high margin or slow moving products should be kept in top shelves, medium margin and fast moving products should be kept in middle shelves, and low margin or bulky products should be kept in bottom shelves).

In some implementations, a two-phased approach can be used to generate the planogram for a given store and assortment combination. In these implementations, phase one can determine the optimal settings of a first set of decision variables (e.g., assignments of products to shelves), and a second set of decision variables (e.g., the sequence of assigned products on a shelf). A third set of variables (e.g., the numbers of facings of a product assigned to a shelf), can be roughly determined in phase one and can be optimized further in phase two (e.g., to determine a final value).

In some implementations, the phase one problem can be decomposed into a sequence of smaller optimization problems. In these implementations, each smaller optimization problem can consist of one or more products. For each smaller optimization problem, the first two sets of decision variables can be optimized. Additionally, one or more product groups can be combined (e.g., from a previous or lower level), to find an optimal solution for a bigger group of products. The stopping point for phase one can be the starting point for phase two. During phase two, the third set of decision variables can be optimized quickly (e.g., based upon the optimal solutions at each product level), without decomposing the overall problem into smaller problems (e.g., the problems solved during phase one with respect to the smaller optimization problems consisting of one or more products). Thus, the solutions provided by phase one can facilitate the solutions sought in phase two.

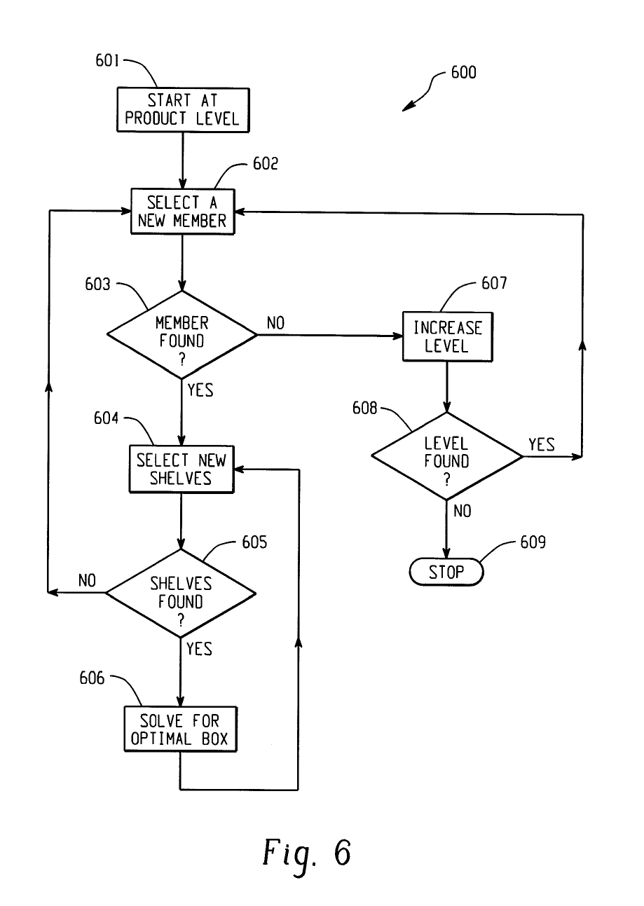

FIG. 6 shows a block diagram example process 600 for phase one. In this example, the system can start at the product level 601 where a product member (e.g., a specific product within a group of specific products) can be selected 602. If a product member is found 603 a set of shelves can be selected 604. If a new set of shelves are selected 605 (e.g., shelves that were not previously selected for this product member), the system can solve for an optimal box 606 with respect to the product member on this set of shelves. In some implementations, a box is defined as a rectangular boundary drawn around the products in a group after placing the products on shelves. In some implementations, an optimal box is defined as the combination of products assigned to the shelves, and the sequence of those assigned products on a shelf that achieves the highest score (e.g., using the weighted sum of the objectives), when compared to all possible optimal boxes that can be formed for this product on these shelves.

If a new set of shelves is not found 605, then the system can select a new product member 602. If no new product members are found 603, the system can check to see if it can increase a level 607 in the hierarchy. If a next higher level is found 608, then the system can repeat the process by selecting a product member 602 at the new level. If the current level is the highest level in the product hierarchy, and a next higher level is not found, then the system can stop 609 and save any scores calculated.

Referring again to FIG. 4, after finding optimal boxes for all product and shelf pairs on a particular level, the system can advance to the next level of subgroups. This process can be repeated at all levels (e.g., levels 401-404) up to and through the planogram level 405. At any level, optimal boxes of previous level can serve as component boxes that can be combined to form optimal boxes for groups at the current level. At the planogram level 405, only one optimal box needs to be formed. The optimal box at the planogram level 405 is the overall solution to phase one.

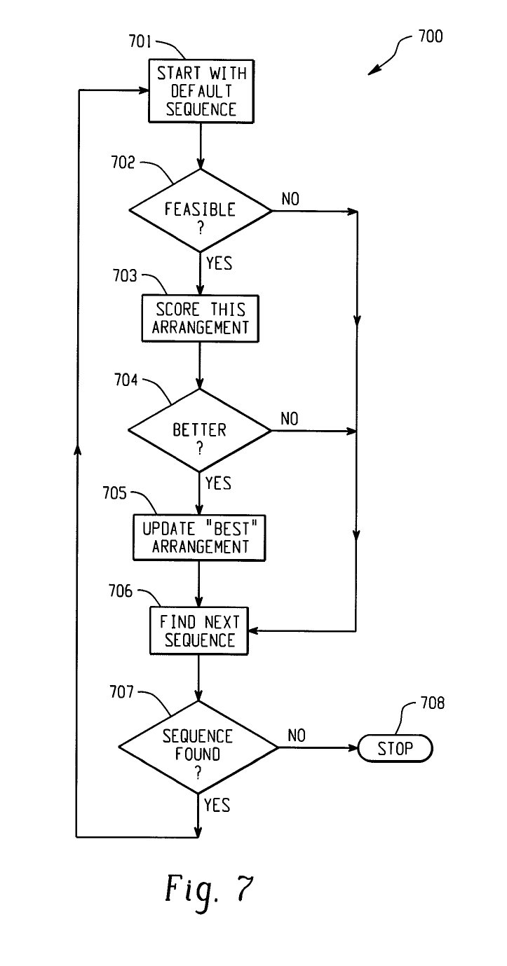

FIG. 7 shows a block diagram example process 700 that can be used to solve for an optimal box at every level in a hierarchical planogram. The process starts when the system selects a default sequence 701 (e.g., a combination of a particular product member and a selected set of shelves). If the sequence is feasible 702, then the combination or arrangement of products and shelves can be scored 703. This score can then be compared to a current best score found, to determine if it is better 704 (e.g., higher), then the current best score. If the score is not better than the current best score, then the system can find the next sequence 706.

If the score is better than the current best score, then the system updates the current best score and saves the current sequence as the current “best” arrangement 705 or “optimal box”. This update to the system allows the best sequence to be used in other score comparisons at each level in the hierarchy. After the current best sequence arrangement has been saved, the system can find the next sequence 706. If a next sequence is found 707, then the system can repeat the process for the new sequence by determining if it is feasible 702. If it is feasible, then it can be scored 703. If it is not feasible, then the system can look to see if a next sequence is available 706 (e.g., found). When no further sequences are found 707, the system can stop the process 708 and the current best sequence arrangement is recorded as the best arrangement.

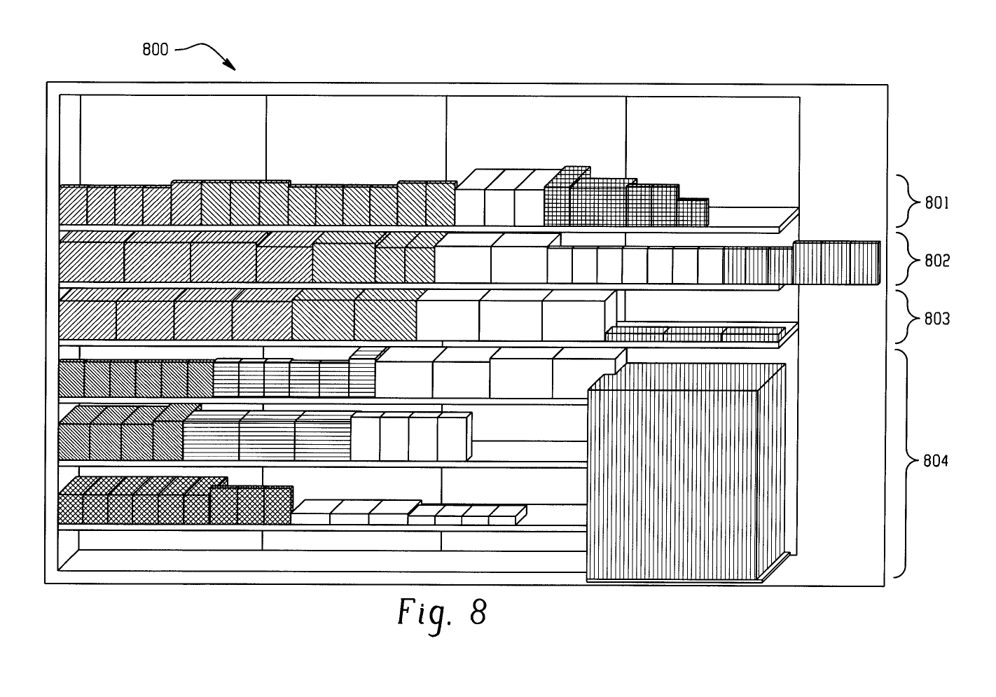

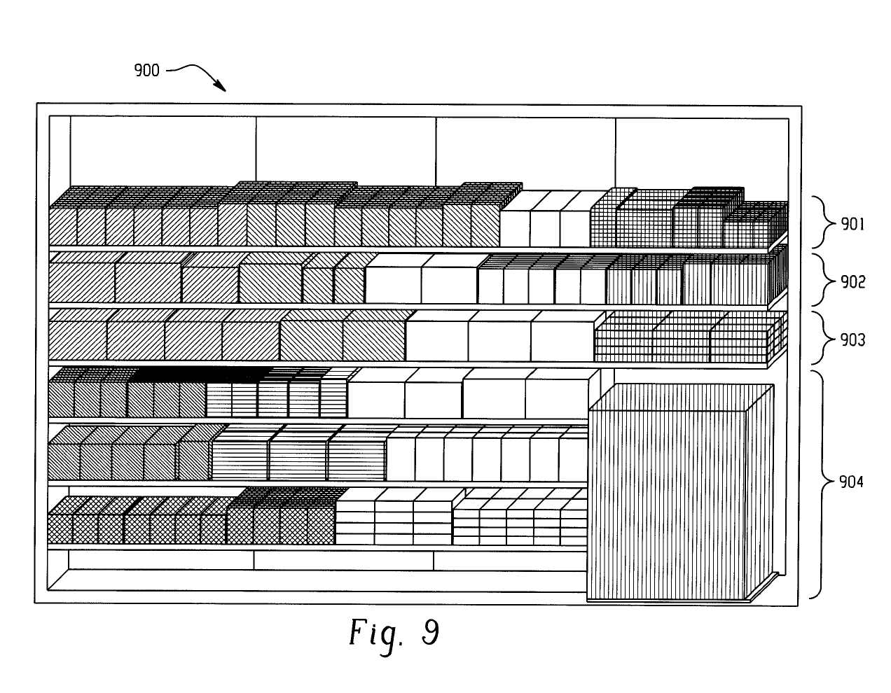

FIG. 8 shows an example planogram 800 before optimization. This planogram shows four areas, 801, 802, 803, and 804, that need to be optimized (e.g., because space is not being used efficiently). FIG. 9 shows an example planogram 900 after optimization. Planogram 900 includes four areas 901, 902, 903, and 904 that correspond respectively to areas 801, 802, 803, and 804 in planogram 800. Areas 901, 902, 903, and 904 clearly show better use of the allotted space after optimization.

In some implementations, a phase two can be performed on an optimal planogram produced at the end of phase one. In phase two, all product boxes can be adjusted so that they are neat and rectangular. Additionally, product placement on shelves can be adjusted so that the shelves are filled, and that no shelves are overflowing with excess facings. During phase two, the system does not need to make any changes to the product sequence or shelf assignment determined in phase one. Instead, the system can expand or contract the number of product facings. For example, if the system (e.g., using a formulation algorithm enumerated below), finds ragged or unbalanced box shapes, then the system can expand or contract product facings to makes the shapes rectangular. In another example, if the system finds empty spots, then the system can expand product facings to fill the gaps. In yet another example, if the system finds overflowing shelves, then the system can contract product facings to accommodate products on shelves. Specific implementations are enumerated below.

In one implementation, excess box width over the specified horizontal span of a product member can be minimized. Specifically, to avoid excessively wide placement of a product member, the excess of horizontal distance between the two vertical lines that bound the placement of a product member over and above the specified horizontal span can be minimized. As the distance approaches or exceeds the specified horizontal span, the penalty becomes steep. This can keep the width of a product member from growing beyond a specified horizontal span (e.g., the shopper's viewpoint).

The objective is formulated in maximization form as follows:

$$s = 100 \cdot \frac{1}{{N}_{p}} {\sum }_{p} {\sum }_{l} {w}_{l} \frac{{H}_{pl} - {h}_{pl}}{{H}_{pl}}$$

### Where:

p—product p
l—layer of horizontal span
Nₚ—Number of products
H−visual frame indicating a large horizontal span beyond which it is difficult to get a good visual perception of a product or affinity group
   Horizontal span for a product is modelled as:

hₚ₁+hₚ₂+hₚ₃+hₚ₄=hₚ

### Where:

hₚ—horizontal span of product p
hₚ₁—horizontal span in layer l span in layer l can be positive only if layers 1 through l-1 have been fully utilized. A typical setting of four layers of horizontal span is shown:
   layer 1: span hₚ₁ is between 0 to 80% of the visual frame H
   layer 2: span hₚ₂ where hₚ₁+hₚ₂ is between 80 to 90% of H
   layer 3: span hₚ₃ where hₚ₁+hₚ₂+hₚ₃ is between 90 to 100% of H
   layer 4: span hₚ₄ where hₚ₁+hₚ₂+hₚ₃+hₚ₄ is between 100 to 110% H
Hₚ₁—upper limit on span in layer l. Thus Hₚ₁ in the example above is 80%. Value of Hₚ₂ is 90%−80%=10%.
w₁—weighted coefficient in the objective for horizontal span in layer l. Assuming non-weighted values of 1, 2, 4, and 8 for the four layers, values of w₁ are set as:

w₁=1/(1+4+20+25)=0.02

w₂=4/(1+4+20+25)=0.08

w₃=20/(1+4+20+25)=0.40

w₄=25/(1+4+20+25)=0.50

Referring again to FIG. 5, example planogram 500 includes 7 placed products (A, B, C, D, E, F, and G). Chart 2 below, includes a visual frame of 40 inches for FIG. 5. In this example, Product E is scored.

| | CHART 2 | | | | | | |
|---|---|---|---|---|---|---|---|
| | Product | | | | | | |
| | A | B | C | D | E | F | G |
| Horizontal span: hₚ | 15 | 38 | 35 | 32 | 42 | 38 | 36 |
| X₁ | (32 − 15)/32 = | 0 | 0 | 0 | 0 | 0 | 0 |
| | 0.53125 | | | | | | |
| X₂ | (8 − 0)/8 = 1 | 0 | (4 − 3)/4 = | 1 | 0 | 0 | 0 |
| | | | 0.25 | | | | |
| X₃ | 1 | 0.5 | 1 | 1 | 0 | 0.5 | 1 |
| X₄ | 1 | 1 | 1 | 1 | (4 − 2)/4 = | 1 | 1 |
| | | | | | 0.5 | | |

where x₁ denotes (Hₚ₁−hₚ₁)/Hₚ₁.

### Scoring for Product E:

Product E has a horizontal span of 42.
Layer 1 covers span from 0 to 32 (80% of the visual frame).
Thus layer 1 results in (Hₚ₁−hₚ₁)/Hₚ₁=(32−32)/32=0.
Layer 2 goes from span of 32 to 36. Hence, layer 2 results in (Hₚ₂−hₚ₂)/Hₚ₂=(4−4)/4=0.
Similarly, layer 3 results in (4−4)/4=0.
Layer 4 goes from 40 to 44 resulting in (4−2)/2=0.5
Applying the weighted coefficients for the layers leads to 0+4*0+20*0+25*0.5)/50=12.5/50=0.25
Add scores for each product and divide the sum by the number of products:

Score=100*(49.53125+35+46+49+12.5+35+45)/50*6=90.67

In one implementation, the excess of vertical span of a product member over its ideal vertical span can be minimized. Specifically, to avoid fragmentation of a product, the excess of vertical distance (measured in number of shelves between the two horizontal lines that bound the placement of a product member) over the ideal vertical span, is minimized. As the vertical distance approaches or exceeds the ideal vertical span, the penalty becomes steep. Maximum number of shelves is bounded by the number of shelves in a fixture. In some implementations, the ideal vertical span for a product member can be determined by placing the recommended facings of products in the product member such that the width of the box remains within the specified horizontal span (e.g., by placing a large product member on multiple shelves). Thus, in some implementations, the ideal vertical span of a large product member can span over multiple shelves.

This objective can be formulated in maximization form as follows:

$$s = 100 \cdot \frac{1}{{N}_{p}} {\sum }_{p} {\sum }_{l} {w}_{l} \frac{{V}_{pl} - {v}_{pl}}{{V}_{pl}}$$

### Where:

p—product p
l—a shelf in vertical span
Nₚ—Number of products
   Vertical span for a product is modelled as:

Vₚ^{min}+vₚ₁+vₚ₂+vₚ₃+vₚ₄=vₚ

### Where:

vₚ—vertical span of product p
vₚ₁—1 if product p is placed on at least l shelves beyond the minimum needed shelves
   Thus vₚ₂=1 if product p is placed on at least 2 shelves in addition to the minimum needed shelves. If product is placed on 2 additional shelves then both vₚ₁ and vₚ₂=1 leading to vₚ as minimum shelves+2, the vertical span of p.
V^{min}ₚ—minimum number of shelves needed to place recommended facings of product p if the horizontal span of product remains within the visual frame. No penalty is imposed for using these shelves.
Vₚ₁—1 if product p can potentially be placed on up to l shelves beyond V^{min}ₚ. Thus if product p can be placed on 4 shelves where minimum is 1 then Vₚ₁ to Vₚ₃=1.
w₁—weighted coefficient in the objective for vertical span in layer l beyond the minimum shelves needed for a product. Assuming non-weighted values of 1, 2, 3, and 4 for placing product on 1, 2, 3, or 4 shelves beyond the minimum shelves, values of w₁ are set as:

w₁=1/(1+2+3+4)=0.1

w₂=2/(1+2+3+4)=0.2

w₃=3/(1+2+3+4)=0.3

w₄=4/(1+2+3+4)=0.4

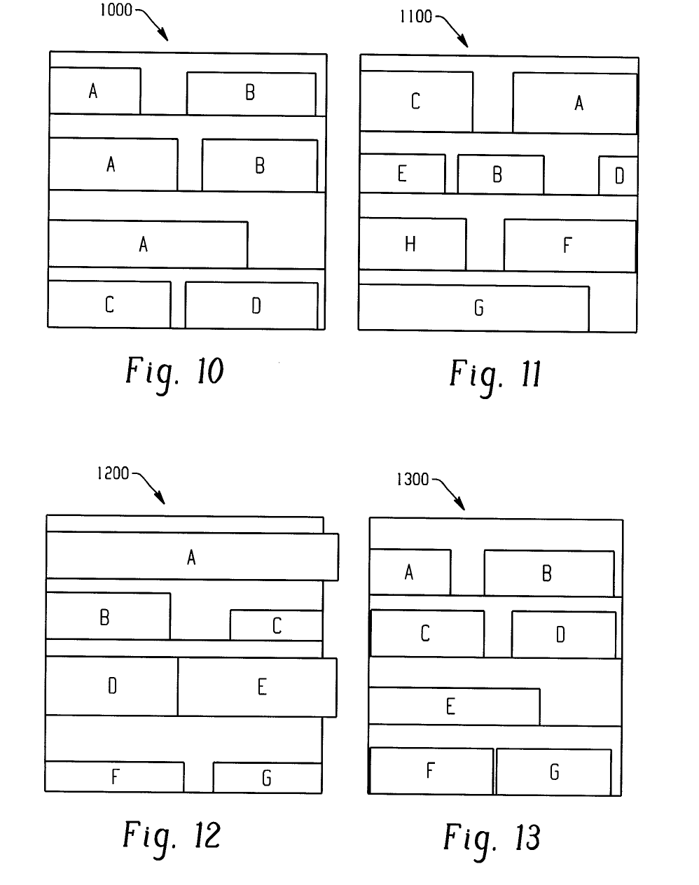

FIG. 10 shows an example planogram 1000 that includes 7 placed products (A, B, A, B, A, C, and D). Chart 3 below is based upon a maximum number of shelves that a product can be placed on being limited to 4 shelves. In this example, Product B is scored.

CHART 3

Product

| | A | B | C | D |
|---|---|---|---|---|
| Vertical span: vₚ | 3 | 2 | 1 | 1 |
| V^{min}ₚ | 2 | 1 | 1 | 1 |
| X₁ | (1 − 1)/1 = 0 | 0 | 1 | 1 |
| X₂ | 1 | 1 | 1 | 1 |
| X₃ | 1 | 1 | 1 | 1 |
| X₄ | 1 | 1 | 1 | 1 |

where x₁ denotes (Vₚ₁−vₚ₁)/Vₚ₁.

### Scoring for Product B:

Product B has a horizontal span of 2 and needs at least one shelf.
The maximum number of shelves that B can be potentially placed on beyond minimum is 4.
Since B is placed on 1 shelf beyond minimum of 1, vₚ₁ is 1 and Vₚ₂ to Vₚ₄ are 0.
Applying the weighted coefficients, score of B is calculated as:

100*(0.1*0+0.2*1+0.3*1+0.4*1)=90

Add scores for each product and divide the sum by the number of products:

Score=100*(0.9+0.9+1+1)/4=9.

In some implementations, a display order can be maintained by matching the product sequence to the product sequence defined in the best practice template (BPT). Thus, planograms that conform to the display order defined in the BPT (Corporate display order), will receive the highest scores. In this implementation, the actual product sequence can be compared to the sequence defined in the BPT. If any differences exist, then the system can calculate the average of the distances to the correct neighbor as a fraction of the maximum possible distance between two products.

$$s = 100 \cdot ( 1 - \frac{1}{n} \frac{1}{{d}_{m}} {\sum }_{p} {r}_{p} )$$

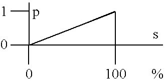

### Where:

dₘ—maximum possible distance between two products
rₚ—distance to desired right-hand neighbor of product p
n—Number of products

The maximum possible distance between two products is the distance between the bottom-left and upper-right corners of the planogram and may be calculated as the square of (Number of products−1) divided by 2.

FIG. 11 shows an example planogram 1100 that includes 8 placed products (C, A, E, B, D, H, F, and G). Chart 4 below is based upon these 8 placed products and receives an overall score of 51.02. Thus, in this example, planogram 1100 does not conform very well with the BPT.

CHART 4

| Sequence | BPT Order | Product Order | Score |
|---|---|---|---|
| 1 | A | C | Distance to D = 3 |
| 2 | B | A | Distance to B = 1 |
| 3 | C | E | Distance to F = 3 |
| 4 | D | B | Distance to C = 2 |
| 5 | E | D | Distance to E = 1 |
| 6 | F | H | Distance to last position 1 |
| 7 | G | F | Distance to G = 0 |
| 8 | H | G | Distance to H = 1 |

$\begin{matrix}Score = 100 * ( 1 - [ ( 3 + 1 + 3 + 2 + 1 + 1 + 1 ) / ( ( 7 * 7 ) / 2 ) ] ) \\ = 100 * ( 1 - [ 12 / ( 49 / 2 ) ] \\ = 100 * ( 1 - 0.4898 ) \\ = 51.02\end{matrix}$

In some implementations, desirability of horizontal placement can be maximized (e.g., products can be placed towards the left edge or right edge of the planogram), based upon one or more product attributes (e.g., brand, margin, and sales volume).

The objective is formulated in maximization form as follows:

$$s = 100 \cdot \frac{1}{{N}_{p h} {N}_{s}} {\sum }_{p} {\sum }_{s} \frac{{W}_{s} - {u}_{p s}}{{W}_{s}}$$

### Where:

p—product p
s—shelf
Nₚₕ—Number of products that needs to placed by either left or right edge of planogram
Nₛ—Number of shelves
Wₛ—Width of shelf s
uₚₛ—horizontal distance of product p from the desired edge on shelf s. If the attributes of product p require the product to be placed towards the left edge of the planogram then uₚₛ denotes the distance of the left edge of the planogram from the left edge of the product block on shelf s. If product is not placed on a shelf then the distance is taken to be zero.

Referring again to FIG. 11, planogram 1100 includes 8 placed products (C, A, E, B, D, H, F, and G). In this example, products C, E, and B need to be by left edge and products A and F need to be by right edge and the width of shelves, Wₛ, is 1. Chart 5 below is based upon these 8 placed products and receives an overall score of 98.0. Thus, in this example, the horizontal placement of products is maximized well with respect to the product attributes.

CHART 5

| | Distance | |
|---|---|---|
| Product | from edge | Score |
| A | 0 (right) | [(1 − 0) / 1 + 1 + 1 + 1] / 4 = 1 |
| B | 0.4 (left) | [(1 − 0.4) / 1 + 1 + 1 + 1] / 4 = 3.6/4 = 0.9 |
| C | 0 (left) | [(1 − 0) / 1 + 1 + 1 + 1] / 4 = 1 |
| E | 0 (left) | [(1 − 0) / 1 + 1 + 1 + 1] / 4 = 1 |
| F | 0 (right) | [(1 − 0) / 1 + 1 + 1 + 1] / 4 = 1 |

$\begin{matrix}Score = 100 * ( 1 + 0.9 + 1 + 1 + 1 ) / 5 \\ = 100 * 0.98 \\ = 98.0\end{matrix}$

In some implementations, desirability of vertical placement can be maximized (e.g., products can be placed towards the top or bottom edges of the planogram), based upon one or more product attributes (e.g., weight, margin, and sales volume).

The objective is formulated in maximization form as follows:

$$s = 100 \cdot \frac{1}{{N}_{pv} {N}_{s}} {\sum }_{p} {\sum }_{s} \frac{( {N}_{s} - 1 ) \times {r}_{p} - {v}_{p s} \times {n}_{p s}}{( {N}_{s} - 1 ) \times {r}_{p}}$$

### Where:

p—product p
s—shelf
Nₚᵥ—Number of products that needs to placed by either top or bottom edge of planogram
Nₛ—Number of shelves
rₚ—recommended number of facings for product p
nₚₛ—actual number of facings of product p on shelf s
vₚₛ—difference in shelf indices between shelf s and the desired shelf (top or bottom) for product p. If the attributes of product p require the product to be placed near top shelf of the planogram then vₚₛ denotes the difference between 1 (top shelf) and s where shelves are numbered from top.

In some implementations, if an attribute binds a product to be placed on a particular shelf (e.g., a ‘heavy’ product can be placed on a ‘bottom’ shelf only), then it will be treated as constraint in the optimization formulation. In these implementations, such binding attributes are not needed as part of the determination.

Referring again to FIG. 11, planogram 1100 includes 8 placed products (C, A, E, B, D, H, F, and G). In this example, Products A, B, and C need to be by the top edge and product G needs to be by the bottom edge. The total number of shelves is 4, and the number of actual and recommended facings for each product is 2. Chart 6 below is based upon these 8 placed products and receives an overall score of 97.2. Thus, in this example, the vertical placement of products is maximized well with respect to the product attributes.

CHART 6

| | Distance | |
|---|---|---|
| Product | from edge | Score |
| A | 0 (top) | [(3 × 2 − 0 × 2) / 3 × 2 + 1 + 1 + 1] / 4 = 1 |
| A | | |
| B | 2 − 1 = 1 | [(3 × 2 − 1 × 2) / 3 × 2 + 1 + 1 + 1] / 4 = |
| | (top) | 3.66/4 = 0.917 |
| C | 0 (top) | [(3 × 2 − 0 × 2) / 3 × 2 + 1 + 1 + 1] / 4 = 1 |
| G | 0 (bottom) | [(3 × 2 − 0 × 2) / 3 × 2 + 1 + 1 + 1] / 4 = 1 |

$\begin{matrix}Score = 100 * ( 1 + 0.917 + 1 + 1 ) / 4 \\ = 100 * 0.9792 \\ = 97.2\end{matrix}$

In some implementations, products need to be kept within a fixed shelf length (e.g., to avoid overhanging products at the ends of the shelves). Thus, the overhang of products beyond shelf width is minimized, and as overhang increases, the penalty becomes steep.

The objective is formulated in maximization form as follows:

$$s = 100 \cdot \frac{1}{{N}_{s}} {\sum }_{s} {\sum }_{l} {w}_{l} \frac{{O}_{sl} - {o}_{sl}}{{O}_{sl}}$$

### Where:

s—shelf s
Wₛ—width of shelf s
Nₛ—number of shelves
   Overhang for shelfs is modelled as:

Wₛ+oₛ₁+oₛ₂+oₛ₃+oₛ₄≧Fₛ

Where:
Fₛ—total width of all facings placed on shelf s
oₛ₁—overhang in layer l for shelf s where overhang in layer l can be positive only if layers l through l-1 have been fully utilized.
A typical setting of four layers of overhang ranges is shown:
layer 1: overhang oₛ₁ is between 0 to 1 units of width
layer 2: overhang oₛ₂ is between 1 to 2 units of width where oₛ₁+oₛ₂ is between 0 to 2
layer 3: overhang oₛ₃ is between 2 to 3 units of width where oₛ₁+oₛ₂+oₛ₃ is between 0 to 3
layer 4: overhang oₛ₄ is between 3 to 4 units of width where oₛ₁+oₛ₂+oₛ₃+oₛ₄ is between 0 to 4
Oₛ₁—upper limit on overhang in layer l. Thus Oₛ₁ in the example above is 1 unit of width.
Value of Oₛ₂ is 2−1=1 unit of width.
w₁—weighted coefficient in the objective for overhang in layer l beyond the shelf width.
Assuming non-weighted values of 1, 2, 3, and 4 for overhang, values of w₁ are set as:

w₁=1/(1+2+3+4)=0.1

w₂=2/(1+2+3+4)=0.2

w₃=3/(1+2+3+4)=0.3

w₄=4/(1+2+3+4)=0.4

Total overhang for a shelf is limited by 4 units of width in this example. Upper limits on layers can be adjusted to reflect the tolerance for overhang.

FIG. 12 shows an example planogram 1200 that includes 7 placed products (A, B, C, D, E, F, and G). Chart 7 below is based upon these 7 placed products and receives an overall score of 77.5. Thus, in this example, planogram 1200 does not fit products onto the shelves to avoid overhang.

### CHART 7

Shelf length=100 units of width. Overhang is limited to 4 units.
Number of shelves=4
Shelf 1 overhang=2
Shelf 2 overhang=0
Shelf 3 overhang=3
Shelf 4 overhang=0

$$\begin{matrix}Score = 100 ⋆ ( 1 / 4 ) ⋆ [ \begin{matrix}\begin{matrix}\begin{matrix}( 0.1 ⋆ 0 + 0.2 ⋆ 0 + 0.3 ⋆ 1 + 0.4 ⋆ 1 ) + \\ ( 0.1 ⋆ 1 + 0.2 ⋆ 1 + 0.3 ⋆ 1 + 0.4 ⋆ 1 ) +\end{matrix} \\ ( 0.1 ⋆ 0 + 0.2 ⋆ 0 + 0.3 ⋆ 0 + 0.4 ⋆ 1 ) +\end{matrix} \\ ( 0.1 ⋆ 1 + 0.2 ⋆ 1 + 0.3 ⋆ 1 + 0.4 ⋆ 1 )\end{matrix} ] \\ = 100 ⋆ 3.1 / 4 \\ = 77.5\end{matrix}$$

In some implementations, placed products can be compared with the recommended number of units for all products and a calculation can be made using the following function to account for any shortfall in units. The best score can be found when all products have at least the recommended number of units.

$$s = 100 \cdot \frac{1}{{\sum }_{p} {k}_{p}} ( {\sum }_{p} {\sum }_{l} {k}_{p} {w}_{l} \frac{{F}_{pl} - {f}_{pl}}{{F}_{pl}} )$$

### Where:

p—product p
l—layer of shortfall
kₚ—priority of product p based on a subassortment KPI of choice
Iₚ—index of the priority of product
K—possible number of priority values, e.g. 4 if products are divided in four categories based on a subassortment KPI of choice. In this case, priority Iₚ for product p can be from 1 to 4 depending on the KPI value of product p. Four priority values (kₚ) used in this example are 1.75, 1.5, 1.25, and 1 with corresponding indices (Iₚ) of 1, 2, 3, and 4 respectively.
rₚ—recommended number of units for product p

Shortfall in placing the recommended number of units can be modeled as the sum of four variables.

Thus, shortfall in placing facings of product is captured as:

nₚ+fₚ₁+fₚ₂+fₚ₃+fₚ₄≧rₚ

### Where:

nₚ—number of units of product p
fₚ₁—shortfall in layer l while placing product p, where shortfall in layer l can be positive only if layers 1 through l-1 have been fully utilized. A typical setting of four layers of shortfall ranges is shown:
layer 1: shortfall fₚ₁ is between 0 to 10% of recommended units
layer 2: shortfall fₚ₂ where fₚ₁+fₚ₂ is between 10 to 30% of recommended units
layer 3: shortfall fₚ₃ where fₚ₁+fₚ₂+fₚ₃ is between 30 to 80% of recommended units
layer 4: shortfall fₚ₄ where fₚ₁+fₚ₂+fₚ₃+fₚ₄ is between 80 to 100% of recommended units.
Fₚ₁—upper limit on shortfall in layer l. Thus Fₚ₁ in the example above is 10% of recommended units.
Value of Fₚ₂ is 30%−10%=20% of recommended units.
w₁—weighted coefficient in the objective for shortfall in layer l. Assuming non-weighted values of 1, 4, 20, and 25 for the four layers, values of w₁ are set as:

w₁=1/(1+4+20+25)=0.02

w₂=4/(1+4+20+25)=0.08

w₃=20/(1+4+20+25)=0.40

w₄=25/(1+4+20+25)=0.50

FIG. 13 is an example planogram 1300 including 7 placed products (A, B, C, D, E, F, and G). Chart 8 below, includes recommended units for FIG. 13. The recommended units can be compared to actual facings in FIG. 13 using the scoring method below. In this example, Product F is scored.

| | CHART 8 | | | | | | |
|---|---|---|---|---|---|---|---|
| | Product | | | | | | |
| | A | B | C | D | E | F | G |
| Recommended | 20 | 40 | 20 | 20 | 50 | 40 | 30 |
| units | | | | | | | |
| KPI based | 1.75 | 1.75 | 1.5 | 1.5 | 1.25 | 1 | 1 |
| Priority | | | | | | | |
| Actual | 20 | 40 | 20 | 20 | 60 | 30 | 20 |
| | | | | | (excess) | (short) | (short) |
| X₁ | 1 | 1 | 1 | 1 | 1 | 0 | 0 |
| X₂ | 1 | 1 | 1 | 1 | 1 | 0.25 | 0 |
| X₃ | 1 | 1 | 1 | 1 | 1 | 1 | 0.9333 |
| X₄ | 1 | 1 | 1 | 1 | 1 | 1 | 1 |

Where x₁ denotes (Fₚ₁−fₚ₁)/Fₚ₁ depending on the presence of shortfall in actual units for layer l.

### Scoring for Product F:

Product F has a shortfall of 10 units.
Layer 1 covers excess from 0 to 4 (10% of the recommended units, i.e. 40). Thus shortfall in layer 1 results in (Fₚ₁−fₚ₁)/Fₚ₁=(4−4)/4=0.
Layer 2 goes from excess of 4 to 12.
Excess in layer 2 results in (Fₚ₂−fₚ₂)/Fₚ₂=(8−6)/8=0.25
Since product F (priority index of 1) has shortfall in units, we need to use priority of 1.
Applying the priority and weighted coefficients for the layers related to excess leads to

1.0*(0+4*0.25+20*1+25*1)/50=1.0*46/50=0.92
Add scores for each product in both excess and shortfall layers and divide the sum by the sum of priorities to get the final score:

Score=100*(1.75*1+1.75*1+1.5*1+1.5*1+1.25*1+0.92+0.87333)/(1.75+1.75+1.5+1.5+1.25+1+1)=97.88

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus.

The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them, A propagated signal is an artificially generated signal, e.g., a machine-generated electrical, optical, or electromagnetic signal, that is generated to encode information for transmission to suitable receiver apparatus.

A computer program (also known as a program, software, software application, script, or code), can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., on or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of nonvolatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) to LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any from, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed o a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer-implemented method, comprising:
executing instructions in a processor-implemented system for receiving a first selection corresponding to a first level in an item placement configuration, the first selection including two or more first items;
executing instructions in the processor-implemented system for determining a first score for the first selection, wherein scoring includes applying an algorithm to data corresponding to the first items;
executing instructions in the processor-implemented system for receiving a second selection corresponding to a second level in the item placement configuration, the second selection including two or more second items; and
executing instructions in the processor-implemented system for determining a second score for the second selection, wherein scoring includes applying an algorithm to the first score and data corresponding to the second items.

2. The method of claim 1, further comprising:
executing instructions in the processor-implemented system for determining if there is a saved score corresponding the first selection, and
executing instructions in the processor-implemented system for using the higher of the saved score or the first score to determine the second score.

3. The method of claim 2, further comprising:
executing instructions in the processor-implemented system for replacing the saved score with the first score, when the first score is higher.

4. The method of claim 1, further comprising:
executing instructions in the processor-implemented system for optimizing the item placement configuration according to one or more objectives including a facings objective, a shape objective, or a sequence objective.

5. A computer-implemented method for determining placements of products with respect to one or more shelves, comprising:
executing instructions in a processor-implemented system for receiving first product placement attribute data including at least one of: product priority data, layer of shortfall, layer of excess data, or product facing data;
executing instructions in the processor-implemented system for creating product placement scores by solving a non-linear product placement mathematical formulation using the first product placement attribute data and one or more product placement objectives, the non-linear product placement mathematical formulation including at least one non-linear interrelationship that exists with respect to the product placement attribute data;
executing instructions in the processor-implemented system for creating product placement configurations with respect to the one or more shelves; and
executing instructions in the processor-implemented system for associating each of the product placement configurations with a product placement score to determine an optimal product placement configuration, the product placement configuration being optimal with respect to the one or more product placement objectives.

6. The computer-implemented method of claim 5, wherein a first product placement score corresponds to a product placement configuration on a first level.

7. The computer-implemented method of claim 6, further comprising:
executing instructions in the processor-implemented system for receiving second product placement attribute data including at least one of: product priority data, layer of shortfall, layer of excess data, or product facing data, the second product placement attribute data corresponding to a product placement configuration on a second level, and
executing instructions in the processor-implemented system for determining a second product placement score for the second product placement attribute data by solving the non-linear product placement mathematical formulation using the first product placement score and the second product placement attribute data.

8. A system, comprising:
a processor;
a computer-readable storage medium containing instructions which when executed on the processor, cause the processor to perform operations including:
receiving a first selection corresponding to a first level in an item placement configuration, the first selection including two or more first items;
determining a first score for the first selection, wherein scoring includes applying an algorithm to data corresponding to the first items;
receiving a second selection corresponding to a second level in the item placement configuration, the second selection including two or more second items; and
determining a second score for the second selection, wherein scoring includes applying an algorithm to the first score and data corresponding to the second items.

9. The system of claim 8, further comprising:
determining if there is a saved score corresponding the first selection, and
using the higher of the saved score or the first score to determine the second score.

10. The system of claim 9, further comprising:
replacing the saved score with the first score, when the first score is higher.

11. The system of claim 8, further comprising:
optimizing the item placement configuration according to one or more objectives including a facings objective, a shape objective, or a sequence objective.

12. Computer-readable storage medium or mediums encoded with instructions that when executed, cause a computer to perform a method for determining placements of products with respect to one or more shelves, the method comprising:
receiving first product placement attribute data including at least one of: product priority data, layer of shortfall, layer of excess data, or product facing data;
creating product placement scores by solving a non-linear product placement mathematical formulation using the first product placement attribute data and one or more product placement objectives, the non-linear product placement mathematical formulation including at least one non-linear interrelationship that exists with respect to the product placement attribute data;
creating product placement configurations with respect to the one or more shelves; and
associating each of the product placement configurations with a product placement score to determine an optimal product placement configuration, the product placement configuration being optimal with respect to the one or more product placement objectives.

13. The method of claim 12, wherein a first product placement score corresponds to a product placement configuration on a first level.

14. The method of claim 13, further comprising:
receiving second product placement attribute data including at least one of: product priority data, layer of shortfall, layer of excess data, or product facing data, the second product placement attribute data corresponding to a product placement configuration on a second level, and
determining a second product placement score for the second product placement attribute data by solving the non-linear product placement mathematical formulation using the first product placement score and the second product placement attribute data.
